(19) United States
(12) Patent Application Publication
(10) Pub. No.: US 2008/0065899 A1
(43) Pub. Date: Mar. 13, 2008

(54) Variable Expressions in Security Assertions

(75) Inventors: Blair B. Dillaway, Redmond, WA (US); Brian A. LaMacchia, Bellevue, WA (US); Moritz Y. Becker, Cambridge (GB); Andrew D. Gordon, Cambridge (GB); Cedric Fournet, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/530,427

(22) Filed: Sep. 8, 2006

(51) Int. Cl. H04L 9/32

(52) U.S. Cl. 713/185

(57) ABSTRACT

A security scheme enables control over variables that are expressed in security assertions. In an example implementation, a security type is implicitly assigned to variables based on their syntactic position within a given assertion. In another example implementation, a security scheme enforces strong variable typing such that each variable in an assertion binds to only a single security type. In yet another example implementation, a security scheme constrains the binding behavior of two variables with respect to each other.

### BACKGROUND

Computers and other electronic devices are pervasive in the professional and personal lives of people. In professional settings, people exchange and share confidential information during project collaborations. In personal settings, people engage in electronic commerce and the transmission of private information. In these and many other instances, electronic security is deemed to be important.

Electronic security paradigms can keep professional information confidential and personal information private. Electronic security paradigms may involve some level of encryption and/or protection against malware, such as viruses, worns, and spyware. Both encryption of information and protection from malware have historically received significant attention, especially in the last few years.

However, controlling access to information is an equally important aspect of securing the safety of electronic information. This is particularly true for scenarios in which benefits are derived from the sharing and/or transferring of electronic information. In such scenarios, certain people are to be granted access while others are to be excluded.

Access control has been a common feature of shared computers and application servers since the early time-shared systems. There are a number of different approaches that have been used to control access to information. They share a common foundation in combining authentication of the entity requesting access to some resource with a mechanism of authorizing the allowed access. Authentication mechanisms include passwords, Kerberos, and x.509 certificates. Their purpose is to allow a resource-controlling entity to positively identify the requesting entity or information about the entity that it requires.

Authorization examples include access control lists (ACLs) and policy-based mechanisms such as the extensible Access Control Markup Language (XACML) or the PrivilEge and Role Management Infrastructure (PERMIS). These mechanisms define what entities may access a given resource, such as files in a file system, hardware devices, database information, and so forth. They perform this authorization by providing a mapping between authenticated information about a requestor and the allowed access to a resource.

As computer systems have become more universally connected over large networks such as the Internet, these mechanisms have proven to be somewhat limited and inflexible in dealing with evolving access control requirements. Systems of geographically dispersed users and computer resources, including those that span multiple administrative domains, in particular present a number of challenges that are poorly addressed by currently-deployed technology.

### SUMMARY

A security scheme enables control over variables that are expressed in security assertions. In an example implementation, a security type is implicitly assigned to variables based on their syntactic position within a given assertion. In another example implementation, a security scheme enforces strong variable typing such that each variable in an assertion binds to only a single security type. In yet another example implementation, a security scheme constrains the binding behavior of two variables with respect to each other.

This Summary is provided to introduce a selection of concepts in a simplified form that are fiber described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, protocol, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example general environment in which an example security scheme may be implemented.

FIG. 2 is a block diagram illustrating an example security environment having two devices and a number of example security-related components.

FIG. 3 is a block diagram illustrating the example security environment of FIG. 2 in which example security-related data is exchanged among the security-related components.

FIG. 4 is a block diagram of an example device that may be used for security-related implementations as described herein.

FIG. 5 is a block diagram illustrating an example assertion format for a general security scheme.

FIG. 6 is a block diagram illustrating multiple aspects of an example variable-controlled security scheme.

FIG. 7 is a block diagram illustrating an example of how assertion syntax can establish variable typing based on syntactic position.

FIGS. 8A and 8B are block diagrams of specific examples of assignments of security types to variables based on syntactic position.

FIG. 9 is a flow diagram that illustrates an example of a method for detecting if an assertion violates strong-typing.

FIG. 10 is a block diagram illustrating an example of a dual variable binding constraint on an assertion.

FIG. 11 is a flow diagram that illustrates an example of a method for detecting if an assertion conforms to a dual variable binding constraint.

FIG. 12 is a block diagram illustrating an example assertion having an assertion variable that is associated with a single variable binding constraint indicator.

### DETAILED DESCRIPTION

### Example Security Environments

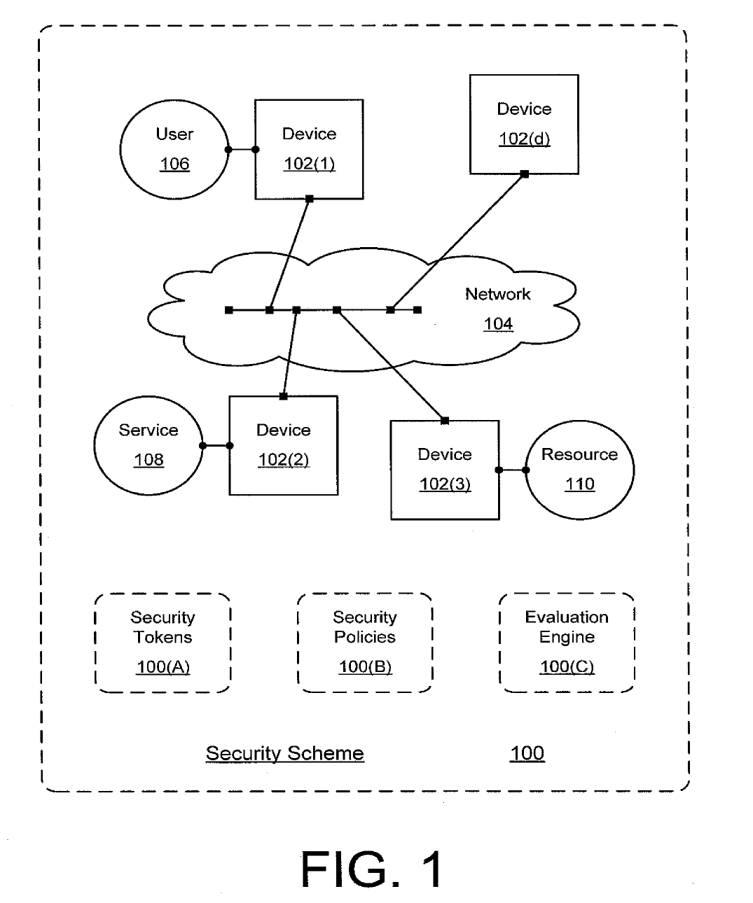

FIG. 1 is a block diagram illustrating an example general environment in which an example security scheme 100 may be implemented. Security scheme 100 represents an integrated approach to security. As illustrated, security scheme 100 includes a number of security concepts: security tokens 100(A), security policies 100(B), and an evaluation engine 100(C). Generally, security tokens 100(A) and security policies 100(B) jointly provide inputs to evaluation engine 100(C). Evaluation engine 100(C) accepts the inputs and produces an authorization output that indicates if access to some resource should be permitted or denied.

In a described implementation, security scheme 100 can be overlaid and/or integrated with one or more devices 102, which can be comprised of hardware, software, firmware, some combination thereof, and so forth. As illustrated, “d” devices, with “d” being some integer, are interconnected over one or more networks 104. More specifically, device 102(1), device 102(2), device 102(3) . . . device 102(d) are capable of communicating over network 104.

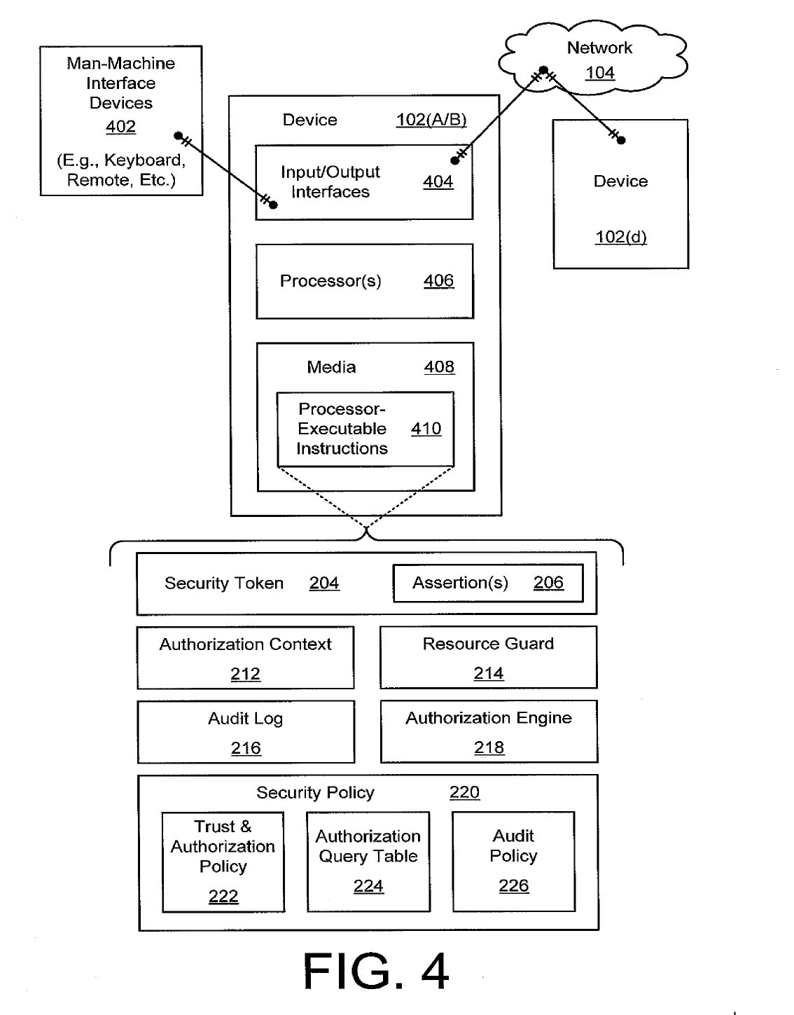

Each device 102 may be any device that is capable of implementing at least a part of security scheme 100. Examples of such devices include, but are not limited to, computers (e.g., a client computer, a server computer, a personal computer, a workstation, a desktop, a laptop, a palm-top, etc.), game machines (e.g., a console, a portable game device, etc.), set-top boxes, televisions, consumer electronics (e.g., DVD player/recorders, camcorders, digital video recorders (DVRs), etc.), personal digital assistants (PDAs), mobile phones, portable media players, some combination thereof, and so forth. An example electronic device is described herein below with particular reference to FIG. 4.

Network 104 may be formed from any one or more networks that are linked together and/or overlaid on top of each other. Examples of networks 104 include, but are not limited to, an internet, a telephone network, an Ethernet, a local area network (LAN), a wide area network (WAN), a cable network, a fibre network, a digital subscriber line (DSL) network, a cellular network, a Wi-Fi® network, a WiMAX® network, a virtual private network (VPN), some combination thereof, and so forth. Network 104 may include multiple domains, one or more grid networks, and so forth. Each of these networks or combination of networks may be operating in accordance with any networking standard.

As illustrated, device 102(1) corresponds to a user 106 that is interacting with it. Device 102(2) corresponds to a service 108 that is executing on it. Device 102(3) is associated with a resource 110. Resource 110 may be part of device 102(3) or separate from device 102(3).

User 106, service 108, and a machine such as any given device 102 form a non-exhaustive list of example entities. Entities, from time to time, may wish to access resource 110. Security scheme 100 ensures that entities that are properly authenticated and authorized are permitted to access resource 110 while other entities are prevented from accessing resource 110.

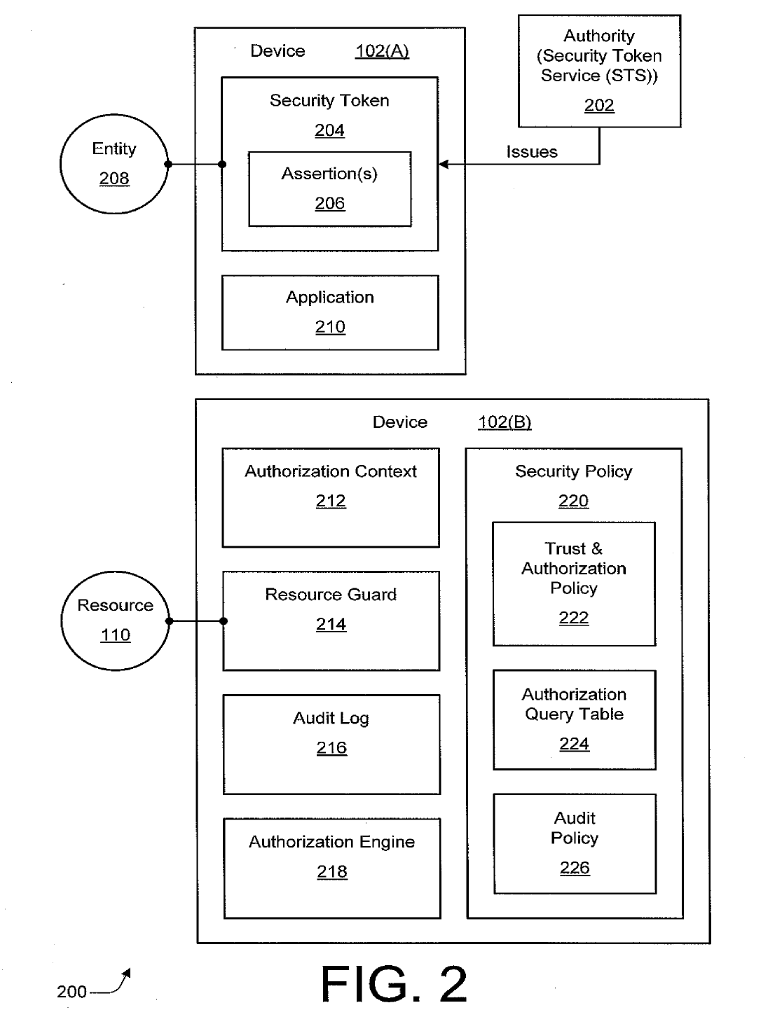

FIG. 2 is a block diagram illustrating an example security environment 200 having two devices 102(A) and 102(B) and a number of example security-related components. Security environment 200 also includes an authority 202, such as a security token service (STS) authority. Device 102(A) corresponds to an entity 208. Device 102(B) is associated with resource 110. Although a security scheme 100 may be implemented in more complex environments, this relatively-simple two-device security environment 200 is used to describe example security-related components.

As illustrated, device 102(A) includes two security-related components: a security token 204 and an application 210. Security token 204 includes one or more assertions 206. Device 102(B) includes five security-related components: an authorization context 212, a resource guard 214, an audit log 216, an authorization engine 218, and a security policy 220. Security policy 220 includes a trust and authorization policy 222, an authorization query table 224, and an audit policy 226.

Each device 102 may be configured differently and still be capable of implementing all or a part of security scheme 100. For example, device 102(A) may have multiple security tokens 204 and/or applications 210. As another example, device 102(B) may not include an audit log 216 or an audit policy 226. Other configurations are also possible.

In a described implementation, authority 202 issues security token 204 having assertions 206 to entity 208. Assertions 206 are described herein below, including in the section entitled “Security Policy Assertion Language Example Characteristics”. Entity 208 is therefore associated with security token 204. In operation, entity 208 wishes to use application 210 to access resource 110 by virtue of security token 204.

Resource guard 214 receives requests to access resource 110 and effectively manages the authentication and authorization process with the other security-related components of device 102(B). Trust and authorization policy 222, as its name implies, includes policies directed to trusting entities and authorizing actions within security environment 200. Trust and authorization policy 222 may include, for example, security policy assertions (not explicitly shown in FIG. 2). Authorization query table 224 maps requested actions, such as access requests, to an appropriate authorization query. Audit policy 226 delineates audit responsibilities and audit tasks related to implementing security scheme 100 in security environment 200.

Authorization context 212 collects assertions 206 from security token 204, which is/are used to authenticate the requesting entity, and security policy assertions from trust and authorization policy 222. These collected assertions in authorization context 212 form an assertion context. Hence, authorization context 212 may include other information in addition to the various assertions.

The assertion context from authorization context 212 and an authorization query from authorization query table 224 are provided to authorization engine 218. Using the assertion context and the authorization query, authorization engine 218 makes an authorization decision. Resource guard 214 responds to the access request based on the authorization decision. Audit log 216 contains audit information such as, for example, identification of the requested resource 110 and/or the algorithmic evaluation logic performed by authorization engine 218.

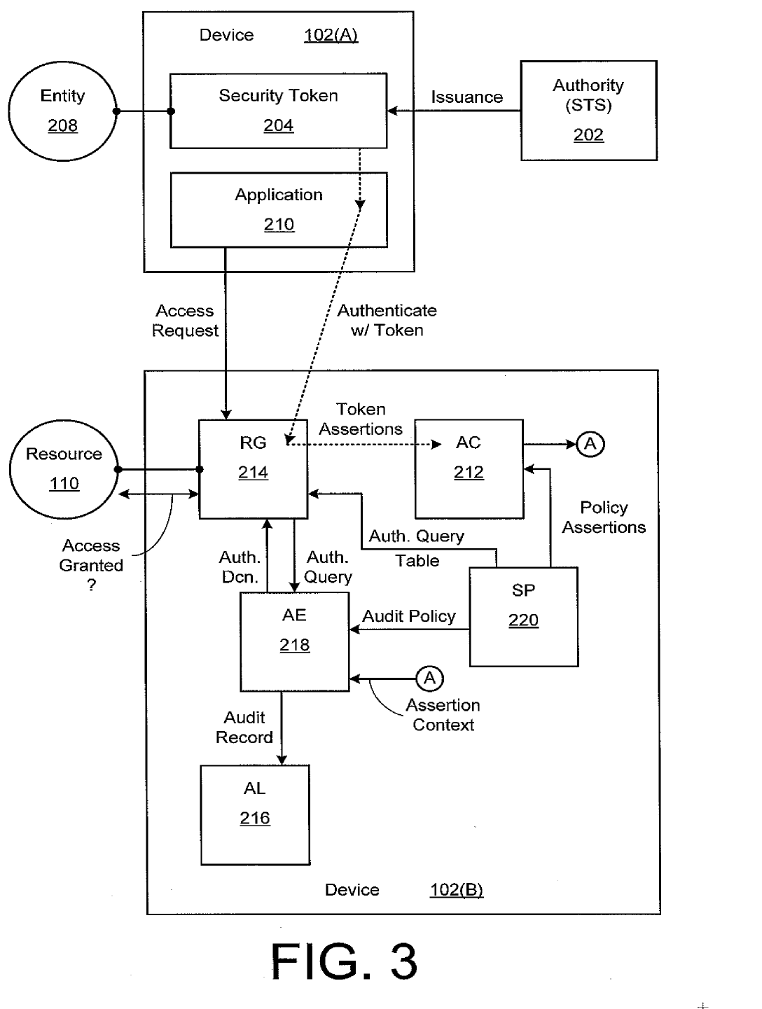

FIG. 3 is a block diagram illustrating example security environment 200 in which example security-related data is exchanged among the security-related components. The security-related data is exchanged in support of an example access request operation. In this example access request operation, entity 208 wishes to access resource 110 using application 210 and indicates its authorization to do so with security token 204. Hence, application 210 sends an access request* to resource guard 214. In this description of FIG. 3, an asterisk (i.e., “*”) indicates that the stated security-related data is explicitly indicated in FIG. 3.

In a described implementation, entity 208 authenticates* itself to resource guard 214 with a token*, security token 204. Resource guard 214 forwards the token assertions* to authorization context 212. These token assertions are assertions 206 (of FIG. 2) of security token 204. Security policy 220 provides the authorization query table* to resource guard 214. The authorization query table derives from authorization query table module 224. The authorization query table sent to resource guard 214 may be confirmed to the portion or portions directly related to the current access request.

Policy assertions are extracted from trust and authorization policy 222 by security policy 220. The policy assertions may include both trust-related assertions and authorization-related assertions. Security policy 220 forwards the policy assertions* to authorization context 212. Authorization context 212 combines the token assertions and the policy assertions into an assertion context. The assertion context* is provided from authorization context 212 to authorization engine 218 as indicated by the encircled “A”.

An authorization query is ascertained from the authorization query table. Resource guard 214 provides the authorization query (auth. query*) to authorization engine 218. Authorization engine 218 uses the authorization query and the assertion context in an evaluation algorithm to produce an authorization decision. The authorization decision (auth. dcn.*) is returned to resource guard 214. Whether entity 208 is granted access* to resource 110 by resource guard 214 is dependent on the authorization decision. If the authorization decision is affirmative, then access is granted. If, on the other hand, the authorization decision issued by authorization engine 218 is negative, then resource guard 214 does not grant entity 208 access to resource 110.

The authorization process can also be audited using semantics that are complementary to the authorization process. The auditing may entail monitoring of the authorization process and/or the storage of any intermediate and/or final products of, e.g., the evaluation algorithm logically performed by authorization engine 218. To that end, security policy 220 provides to authorization engine 218 an audit policy* from audit policy 226. At least when auditing is requested, an audit record* having audit information may be forwarded from authorization engine 218 to audit log 216. Alternatively, audit information may be routed to audit log 216 via resource guard 214, for example, as part of the authorization decision or separately.

FIG. 4 is a block diagram of an example device 102 that may be used for security-related implementations as described herein. Multiple devices 102 are capable of communicating across one or more networks 104. As illustrated, two devices 102(A/B) and 102(d) are capable of engaging in communication exchanges via network 104. Although two devices 102 are specifically shown, one or more than two devices 102 may be employed, depending on the implementation.

Generally, a device 102 may represent any computer or processing-capable device, such as a client or server device; a workstation or other general computer device; a PDA; a mobile phone; a gaming platform; an entertainment device; one of the devices listed above with reference to FIG. 1; some combination thereof; and so forth. As illustrated, device 102 includes one or more input/output (I/O) interfaces 404, at least one processor 406, and one or more media 408. Media 408 include processor-executable instructions 410.

In a described implementation of device 102, 1/0 interfaces 404 may include (i) a network interface for communicating across network 104, (ii) a display device interface for displaying information on a display screen, (iii) one or more man-machine interfaces, and so forth. Examples of (i) network interfaces include a network card, a modem, one or more ports, and so forth. Examples of (ii) display device interfaces include a graphics driver, a graphics card, a hardware or software driver for a screen or monitor, and so forth. Printing device interfaces may similarly be included as part of I/O interfaces 404. Examples of (iii) man-machine interfaces include those that communicate by wire or wirelessly to man-machine interface devices 402 (e.g., a keyboard, a remote, a mouse or other graphical pointing device, etc.).

Generally, processor 406 is capable of executing, performing, and/or otherwise effectuating processor-executable instructions, such as processor-executable instructions 410. Media 408 is comprised of one or more processor-accessible media. In other words, media 408 may include processor-executable instructions 410 that are executable by processor 406 to effectuate the performance of functions by device 102.

Thus, realizations for security-related implementations may be described in the general context of processor-executable instructions. Generally, processor-executable instructions include routines, programs, applications, coding, modules, protocols, objects, components, metadata and definitions thereof, data structures, application programming interfaces (APIs), schema, etc. that perform and/or enable particular tasks and/or implement particular abstract data types. Processor-executable instructions may be located in separate storage media, executed by different processors, and/or propagated over or extant on various transmission media.

Processor(s) 406 may be implemented using any applicable processing-capable technology. Media 408 may be any available media that is included as part of and/or accessible by device 102. It includes volatile and non-volatile media, removable and non-removable media, and storage and transmission media (e.g., wireless or wired communication channels). For example, media 408 may include an array of disks/flash memory/optical media for longer-term mass storage of processor-executable instructions 410, random access memory (RAM) for shorter-term storing of instructions that are currently being executed, link(s) on network 104 for transmitting communications (e.g., security-related data), and so forth.

As specifically illustrated, media 408 comprises at least processor-executable instructions 410. Generally, processor-executable instructions 410, when executed by processor 406, enable device 102 to perform the various functions described herein, including those actions that are illustrated in the various flow diagrams. By way of example only, processor-executable instructions 410 may include a security token 204, at least one of its assertions 206, an authorization context module 212, a resource guard 214, an audit log 216, an authorization engine 218, a security policy 220 (e.g., a trust and authorization policy 222, an authorization query table 224, and/or an audit policy 226, etc.), some combination thereof, and so forth. Although not explicitly shown in FIG. 4, processor-executable instructions 410 may also include an application 210 and/or a resource 110.

### Security Policy Assertion Language Example Characteristics

This section describes example characteristics of an implementation of a security policy assertion language (SecPAL). The SecPAL implementation of this section is described in a relatively informal manner and by way of example only. It has an ability to address a wide spectrum of security policy and security token obligations involved in creating an end-to-end solution. These security policy and security token obligations include, by way of example but not limitation: describing explicit trust relationships; expressing security token issuance policies; providing security tokens containing identities, attributes, capabilities, and/or delegation policies; expressing resource authorization and delegation policies; and so forth.

In a described implementation, SecPAL is a declarative, logic-based language for expressing security in a flexible and tractable manner. It can be comprehensive, and it can provide a uniform mechanism for expressing trust relationships, authorization policies, delegation policies, identity and attribute assertions, capability assertions, revocations, audit requirements, and so forth. This uniformity provides tangible benefits in terms of making the security scheme understandable and analyzable. The uniform mechanism also improves security assurance by allowing one to avoid, or at least significantly curtail, the need for semantic translation and reconciliation between disparate security technologies.

A SecPAL implementation may include any of the following example features: [1] SecPAL can be relatively easy to understand. It may use a definitional syntax that allows its assertions to be read as English-language sentences. Also, its grammar may be restrictive such that it requires users to understand only a few subject-verb-object (e.g., subject-verb phrase) constructs with cleanly defined semantics. Finally, the algorithm for evaluating the deducible facts based on a collection of assertions may rely on a small number of relatively simple rules.

[2] SecPAL can leverage industry standard infrastructure in its implementation to ease its adoption and integration into existing systems. For example, an extensible markup language (XML) syntax may be used that is a straightforward mapping from the formal model. This enables use of standard parsers and syntactic correctness validation tools. It also allows use of the W3C XML Digital Signature and Encryption standards for integrity, proof of origin, and confidentiality.

[3] SecPAL may enable distributed policy management by supporting distributed policy authoring and composition. This allows flexible adaptation to different operational models governing where policies, or portions of policies, are authored based on assigned administrative duties. Use of standard approaches to digitally signing and encrypting policy objects allow for their secure distribution. [4] SecPAL enables an efficient and safe evaluation. Simple syntactic checks on the inputs are sufficient to ensure evaluations will terminate and produce correct answers.

[5] SecPAL can provide a complete solution for access control requirements supporting required policies, authorization decisions, auditing, and a public-key infrastructure (PKI) for identity management. In contrast, most other approaches only manage to focus on and address one subset of the spectrum of security issues. [6] SecPAL may be sufficiently expressive for a number of purposes, including, but not limited to, handling the security issues for Grid environments and other types of distributed systems. Extensibility is enabled in ways that maintain the language semantics and evaluation properties while allowing adaptation to the needs of specific systems.

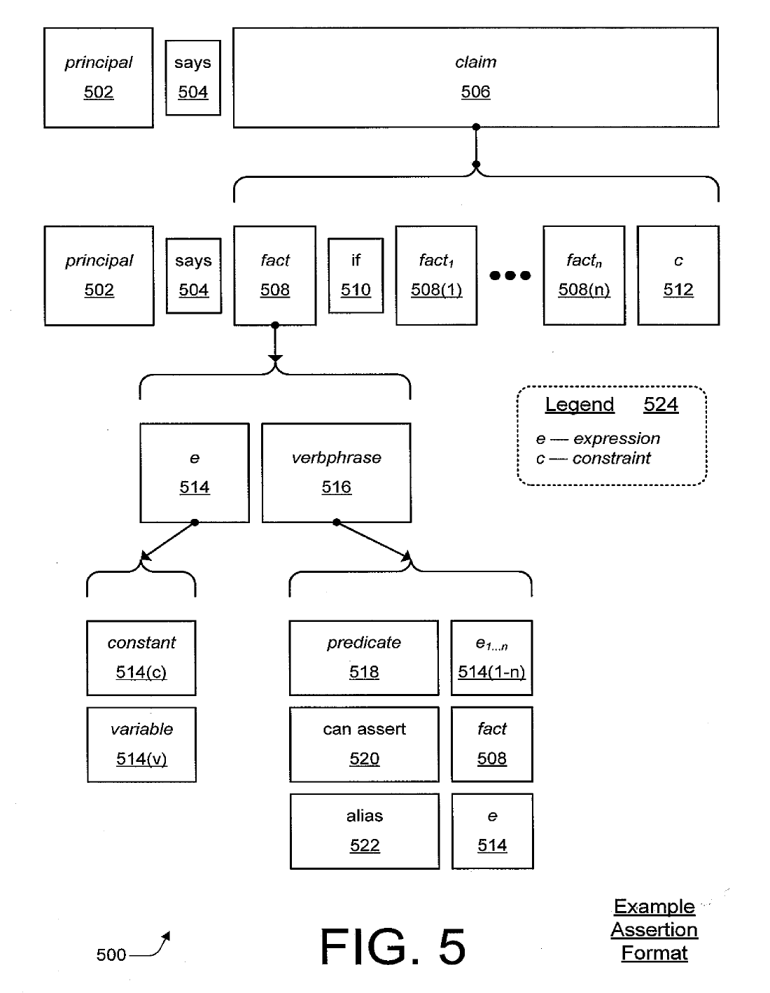

FIG. 5 is a block diagram illustrating an example assertion format 500 for a general security scheme. Security scheme assertions that are used in the implementations described otherwise herein may differ from example assertion format 500. However, assertion format 500 is a basic illustration of one example format for security scheme assertions, and it provides a basis for understanding example described implementation of various aspects of a general security scheme.

As illustrated at the top row of assertion format 500, an example assertion at a broad level includes: a principal portion 502, a says portion 504, and a claim portion 506. Textually, the broad level of assertion format 500 may be represented by: principal says claim.

At the next row of assertion format 500, claim portion 506 is separated into example constituent parts. Hence, an example claim portion 506 includes: a fact portion 508, an if portion 510, “n” conditional fact_{1 . . . n} portions 508(1 . . . n), and a c portion 512. The subscript “n” represents some integer value. As indicated by legend 524, c portion 512 represents a constraint portion. Although only a single constraint is illustrated, c portion 512 may actually represent multiple constraints (e.g., c₁, . . . , cₘ). The set of conditional fact portions 508(1 . . . n) and constraints 512(1 . . . m) on the right-hand side of if portion 510 may be termed the antecedent.

Textually, claim portion 506 may be represented by: fact if fact₁, . . . , factₙ, c. Hence, the overall assertion format 500 may be represented textually as follows: principal says fact if fact₁, . . . , factₙ, c. However, an assertion may be as simple as: principal says fact. In this abbreviated, three-part version of an assertion, the conditional portion that starts with if portion 510 and extends to c portion 512 is omitted.

Each fact portion 508 may also be further subdivided into its constituent parts. Example constituent parts are: an e portion 514 and a verb phrase portion 516. As indicated by legend 524, e portion 514 represents an expression portion. Textually, a fact portion 508 may be represented by: e verbphrase.

Each e or expression portion 514 may take on one of two example options. These two example expression options are: a constant 514(c) and a variable 514(v). Principals may fall under constants 514(c) and/or variables 514(v).

Each verb phrase portion 516 may also take on one of three example options. These three example verb phrase options are: a predicate portion 518 followed by one or more e_{1 . . . n} portions 514(1 . . . n), a can assert portion 520 followed by a fact portion 508, and an alias portion 522 followed by an expression portion 514. Textually, these three verb phrase options may be represented by: predicate e₁ . . . eₙ, can assert fact, and alias e, respectively. The integer “n” may take different values for facts 508(1 . . . n) and expressions 514(1 . . . n).

Generally, SecPAL statements are in the form of assertions made by a security principal. Security principals are typically identified by cryptographic keys so that they can be authenticated across system boundaries. In their simplest form, an assertion states that the principal believes a fact is valid (e.g., as represented by a claim 506 that includes a fact portion 508). They may also state a fact is valid if one or more other facts are valid and some set of conditions are satisfied (e.g., as represented by a claim 506 that extends from a fact portion 508 to an if portion 510 to conditional fact portions 508(1 . . . n) to a c portion 512). There may also be conditional facts 508(1 . . . n) without any constraints 512 and/or constraints 512 without any conditional facts 508(1 . . . n).

In a described implementation, facts are statements about a principal. Four example types of fact statements are described here in this section. First, a fact can state that a principal has the right to exercise an action(s) on a resource with an “action verb”. Example action verbs include, but are not limited to, call, send, read, list, execute, write, modify, append, delete, install, own, and so forth. Resources may be identified by universal resource indicators (URIs) or any other approach.

Second, a fact can express the binding between a principal identifier and one or more attribute(s) using the “possess” verb. Example attributes include, but are not limited to, email name, common name, group name, role title, account name, domain name server/service (DNS) name, internet protocol (IP) address, device name, application name, organization name, service name, account identification/identifier (ID), and so forth. An example third type of fact is that two principal identifiers can be defined to represent the same principal using the “alias” verb.

“Qualifiers” or fact qualifiers may be included as part of any of the above three fact types. Qualifiers enable an assertor to indicate environmental parameters (e.g., time, principal location, etc.) that it believes should hold if the fact is to be considered valid. Such statements may be cleanly separated between the assertor and a relying party's validity checks based on these qualifier values.

An example fourth type of fact is defined by the “can assert” verb. This “can assert” verb provides a flexible and powerfill mechanism for expressing trust relationships and delegations. For example, it allows one principal (A) to state its willingness to believe certain types of facts asserted by a second principal (B). For instance, given the assertions “A says B can assert fact0” and “B saysfact0”, it can be concluded that A believes fact0 to be valid and therefore it can be deduced that “A saysfact0”.

Such trust and delegation assertions may be (i) unbounded and transitive to permit downstream delegation or (ii) bounded to preclude downstream delegation. Although qualifiers can be applied to “can assert” type facts, omitting support for qualifiers to these “can assert” type facts can significantly simplify the semantics and evaluation safety properties of a given security scheme.

In a described implementation, concrete facts can be stated, or policy expressions may be written using variables. The variables are typed and may either be unrestricted (e.g., allowed to match any concrete value of the correct type) or restricted (e.g., required to match a subset of concrete values based on a specified pattern).

Security authorization decisions are based on an evaluation algorithm (e.g., tat may be conducted at authorization engine 218) of an authorization query against a collection of assertions (e.g., an assertion context) from applicable security policies (e.g., a security policy 220) and security tokens (e.g., one or more security tokens 204). Authorization queries are logical expressions, which may become quite complex, that combine facts and/or conditions. These logical expressions may include, for example, AND, OR, and/or NOT logical operations on facts, either with or without attendant conditions and/or constraints.

This approach to authorization queries provides a flexible mechanism for defining what must be known and valid before a given action is authorized. Query templates (e.g., from authorization query table 224) form a part of the overall security scheme and allow the appropriate authorization query to be declaratively stated for different types of access requests and other operations/actions.

### Example Implementations for Variable Expressions in Security Assertions

Access control policies preferably allow the succinct specification of a wide variety of similar cases. For example, one may need to specify that a principal (or group of principals) is authorized to access a number of similarly definable resources or need to specify a set of similarly identifiable principals that have the same access to a given resource. Having to exhaustively enumerate all the combinations of principals and resources in such cases is verbose, difficult to manage, error-prone, and often hard to understand. Unfortunately, this is basically what one is forced to do using access control lists (ACLs), which are arguably the most widely used existing access control policy mechanism. With ACLs, a separate list is used for each resource, and each list contains a separate entry for each principal to indicate its access rights.

A conventional rule-based declarative language, such as XACML, is only marginally better. It is fundamentally based on access rules for matching attribute values against known values. Although this matching is an improvement over ACLs because a single rule can define access rights for multiple principals based on matching attribute values against a pattern, it is still limited and lacks an easy way to parameterize applicable resources and rights.

The existing REL policy language arguably offers a further improvement inasmuch as it allows one to parameterize principals, rights, and resources. However, its mechanisms have weaknesses. The REL approach separates (i) the declaration of a variable, and the values it can bind to, from (ii) the declaration of the type of element it represents. This creates a potential source of errors. It allows, for example, one to declare a variable and then use it simultaneously as both a principal and a right despite the fact that these are incompatible types. It is also ambiguous as to the variable binding behavior. For example, given a variable ‘x’ that can bind to multiple values, with REL it is unspecified as to whether each instance in which the ‘x’ is used can and/or should have the same or a different value.

In contrast, certain implementations as described herein entail strongly typing the variables used in the policy language along with providing an opportunity for explicit control over binding behaviors. In short, a security scheme is described in which there is some measure of certainty about and control over the variables used in policies and other security assertions. For example, there is implicit typing of variables in assertions based on syntactic position (i.e., based on the position or location of the variable within the assertion). Additionally, strong typing of variables may be enforced through syntactic validation against the assertion syntax. Also, there is a mechanism enabling a user to stipulate constraints on the concrete value binding behavior of two or more variables. Furthermore, there is a mechanism enabling a user to stipulate whether a variable can be bound to both other variables and concrete values or only to concrete values.

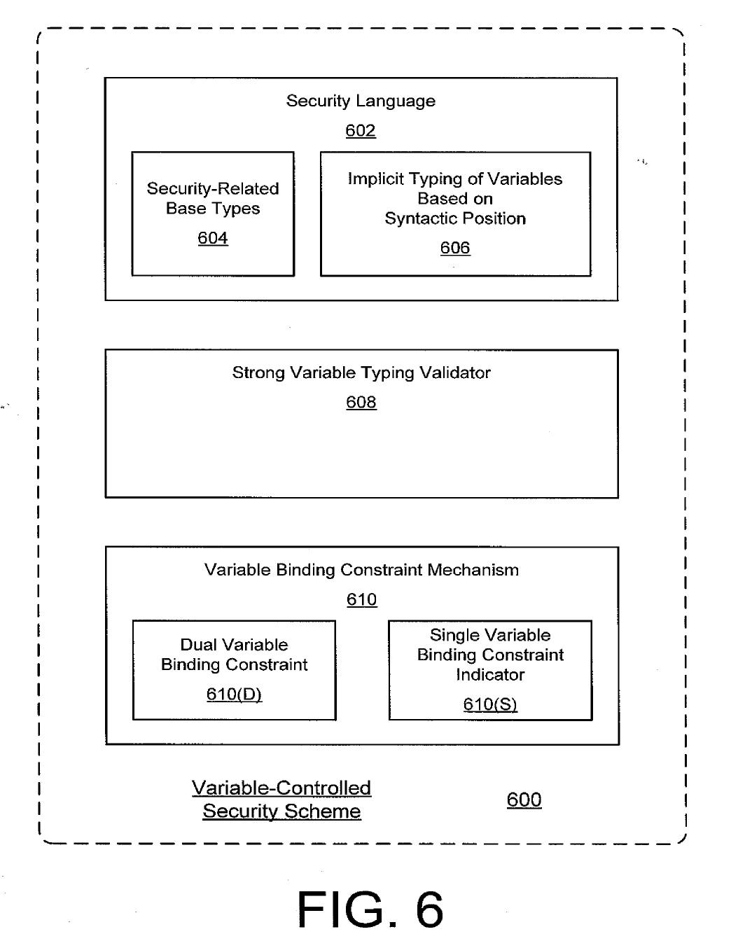

FIG. 6 is a block diagram illustrating multiple aspects of an example variable-controlled security scheme 600. As illustrated, variable-controlled security scheme 600 includes a security language 602, a strong variable typing validator 608, and a variable binding constraint mechanism 610. Security language 602 includes security-related base types 604 and a mechanism for the implicit typing of variables based on syntactic position 606. Variable binding constraint mechanism 610 includes a dual variable binding constraint 610(D) and a single variable binding constraint 610(S).

In a described implementation, variable-controlled security scheme 600 is a security scheme that provides control over the variables that are employed in a given security scenario using security language 602, strong variable typing validator 608, and/or variable binding constraint mechanism 610. Variable binding constraint mechanism 610 may also be considered part of security language 602.

With mechanism 606, variables are implicitly typed to defined security-related types based on their position within assertions. Strong typing is enabled and enforced with strong variable typing validator 608. It may be validated from a syntactic perspective. The variable binding behavior to concrete values may also be constrained using variable binding constraint mechanism 610. These different features and mechanisms provide control over the variables used in a given security scenario.

With regard to security-related base types 604, a number of base types are defined as part of security language 602. Each base type is security-related and supports the implementation of some security-relevant scenario, such as controlling access to a resource. Example base types that are security-related and that may be embodied by variables include, but are not limited to, principal, action verb, resource, attribute, and those that are qualifiers. Example security-related base types that are (e.g., environmental) qualifiers are date-time, location, duration, network connectivity mechanism, and so forth. Other security-related base types, which are not typically embodied by variables, include, but are not limited to, possess, alias, revoke, and can assert.

Example instances of the above-enumerated security-related base types are listed in this paragraph. However, there may be a number of specific types that are derived from a given base type. A principal may be represented by specific types such as a cryptographic key, an account name, a hash code, and so forth. An action verb may be represented by call, send, read, list, execute, write, modify, append, delete, install own, execute, copy, and so forth. A resource may be represented by a file or program, a folder, a communications port, a web site, a processor or computing time, and so forth. An attribute may be represented by an email name, a common name, a group name, a role title, an account name, a DNS name, an IP address, a device name, an application name, an organization name, a service name, an account ID, and so forth.

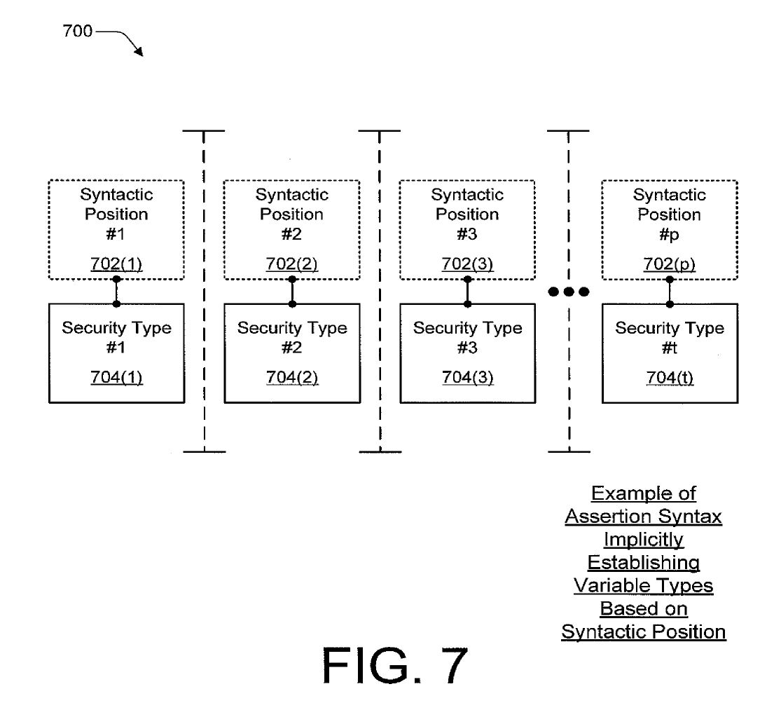

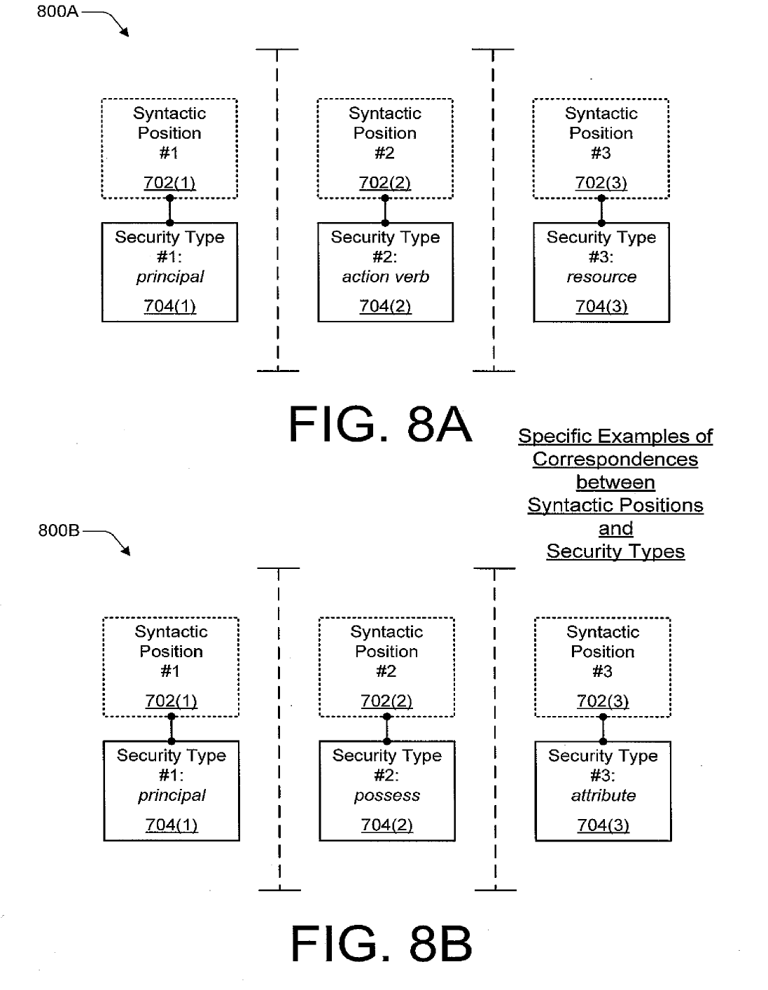

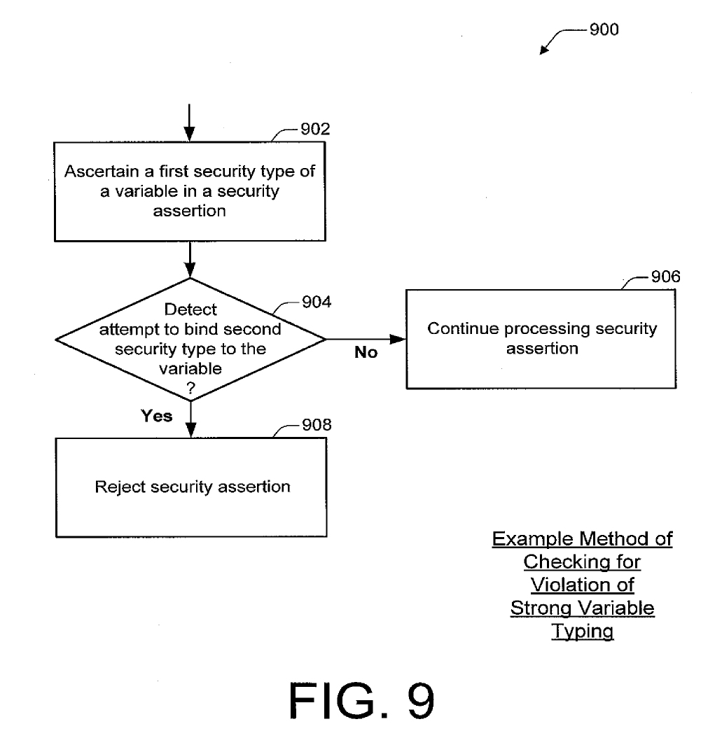

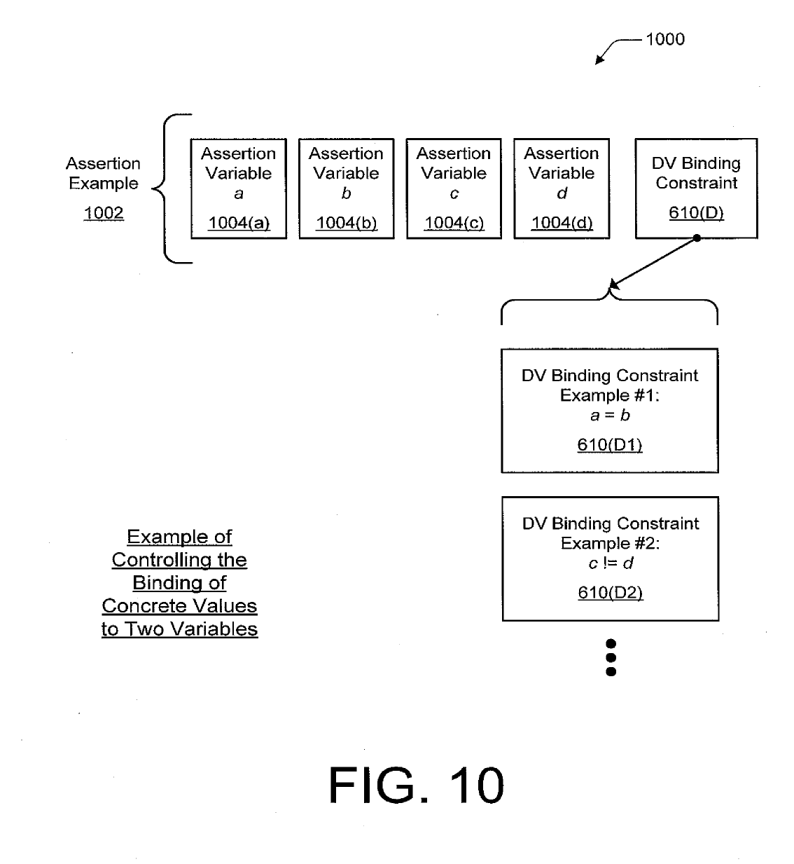

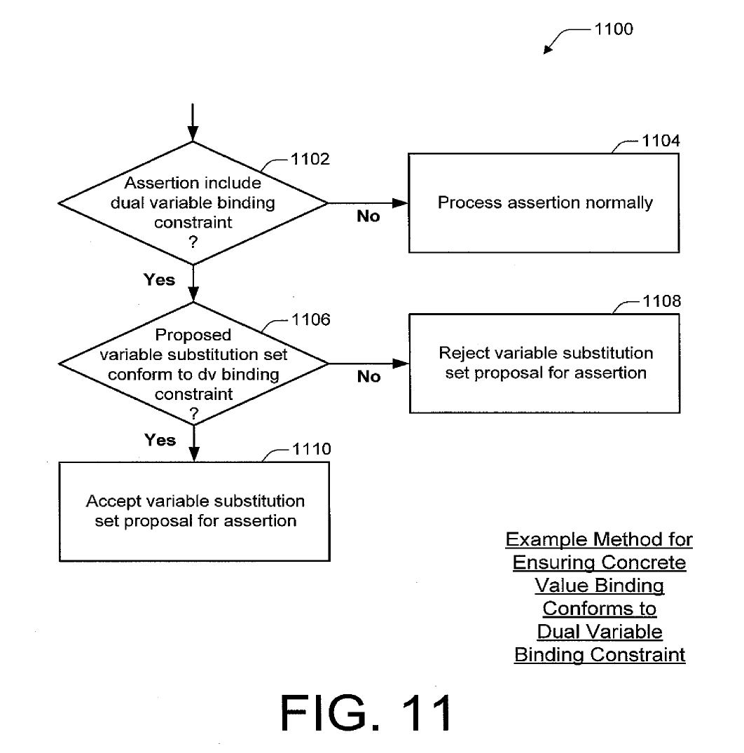

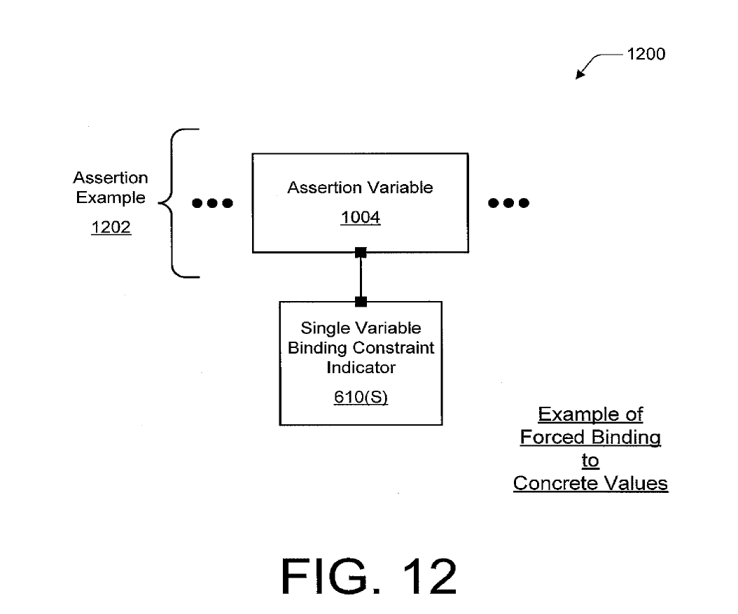

Implicit typing of variables based on syntactic position 606 is described herein below with particular reference to FIGS. 7, 8A, and 8B. Strong variable typing validator 608 is described herein below with particular reference to FIG. 9. Dual variable binding constraint 610(D) is described herein below with particular reference to FIGS. 10 and 11. Single variable binding constraint 610(S) is described herein below with particular reference to FIG. 12.

FIG. 7 is a block diagram 700 illustrating an example of how assertion syntax can establish variable typing based on syntactic position. Each variable, word, or phrase that comprises a base security type in an assertion is considered to represent a slot or space that forms a syntactic position 702. As illustrated, an assertion includes “p” syntactic positions 702, with “p” being some positive integer. Specifically, block diagram 700 includes a syntactic position #1 702(1), a syntactic position #2 702(2), a syntactic position #3 702(3), . . . a syntactic position #p 702(p).

In a described implementation, each syntactic position 702 corresponds to a determinable predefined security base type 704. As illustrated, an assertion may include “t” security types 704, with “t” being some positive integer. Because different syntactic positions 702 may correspond to the same security type 704, the values of “t” and “p” may be different (e.g., “t” may be less than or equal to “p”). Illustrated in block diagram 700 are security type #1 704(1), security type #2 704(2), security type #3 704(3), . . . , security type #t 704(t).

Each respective syntactic position 702 corresponds to a security type 704. As illustrated, syntactic position #1 702(1) corresponds to security type #1 704(1), syntactic position #2 702(2) corresponds to security type #2 704(2), syntactic position #3 702(3) corresponds to security type #3 704(3), . . . , syntactic position #p 702(p) corresponds to security type #t 704(t). These respective correspondences may not be a one-to-one correspondence because two different syntactic positions 702 may correspond to the same security type 704. For example, although no explicitly illustrated, a syntactic position #4 702(4) may also correspond to security type #1 704(1).

Thus, the assertion syntax may implicitly establish variable typing based on the syntactic position of the variables. For example, any variable placed in syntactic position #2 702(2) is implicitly established to be of security type #2 704(2). Similarly, any variable placed in syntactic position #3 702(3) is implicitly established to be of security type #3 704(3).

FIGS. 8A and 8B are block diagrams 800A and 800B of specific examples of assignments of security types to variables based on syntactic position. These two block diagrams are provided by way of illustrated example only. Many other pairs of syntactic positions and corresponding security types may be implemented. Some additional textual examples are also provided below.

As illustrated in block diagram 800A, syntactic position #1 702(1) corresponds to security type #1 704(1), which is a principal in this example. Syntactic position #2 702(2) corresponds to security type #2 704(2), which is an action verb in this example. Syntactic position #3 702(3) corresponds to security type #3 704(3), which is a resource in this example. Hence, an assertion having a fact with three variables of the form “p v r” implicitly types the three variables as follows: variable p is of the type principal, variable v is of the type action verb, and variable r is of the type resource. Consequently, there is no need to separately declare these variables as being of any particular type.

Another example is illustrated in block diagram 800B. Syntactic position #1 702(1) corresponds to security type #1 704(l), which is a principal in this example. Syntactic position #2 702(2) corresponds to security type #2 704(2), which is possess in this example. Syntactic position #3 702(3) corresponds to security type #3 704(3), which is an attribute in this example. Hence, an assertion having a fact with variables p and a that is of the form “p posses a” implicitly types the two variables as follows: variable p is of the type principal and variable a is of the type attribute. These variables are implicitly established as being of a respective type based on the security type corresponding to their syntactic position.

Strong variable typing validator 608 is capable of enforcing strong typing within individual assertions of security language 602. Strong typing implies that each variable may bind to a concrete value of only a single type. Similarly, a variable may not be implicitly assigned two different types.

The scope of a variable is the assertion. Hence, a variable P may bind to two different principals, but it may not bind to one principal and one action verb within a single assertion. This validation may occur syntactically. Syntactic validation situations are described further below, especially by way of example.

Some textual examples of permitted and forbidden assertions due to the strong-typing enforcement are provided here. The following assertion is forbidden:

A says x possess email=a.ms.com if y possess x.

The assertion above is forbidden because the variable x would need to bind to a concrete principal type value on the left and to a concrete attribute type value on the right. A variable within a single assertion is not allowed to take on two different types. The above assertion can be invalidated with a syntactic check.

The following pair of assertions do not violate strong variable typing:

A says B can assert x read Foo;a nd

B says C read x.

In the former assertion, the variable x will bind to a concrete principal value. In the latter assertion, the variable x will bind to a concrete resource value. Nevertheless, the above two assertions are permitted by strong variable typing validator 608 because the variable x can be assigned different types in different assertions.

The following assertion can be disallowed when strong variable typing validator 608 is operating at the syntactic level:

A says B read x if B possess x.

The preceding assertion is forbidden because the variable x cannot be of type resource and type attribute in the same assertion under strong typing. Assertions that are forbidden under the strong typing requirement, such as the assertion above, are rejected. Hence, they are not included as part of an assertion context of authorization context 212. They therefore do not impact an authorization decision that is made using an authorization query in conjunction with an assertion context.

In short, syntactic checks may be sufficient to validate that variables of a given assertion are strongly typed within the given assertion and/or to determine that one or more variables fail to be strongly typed. To enforce strong variable typing, strong variable typing validator 608 can therefore operate at a syntactic level and exclude assertions that fail to be strongly typed.

FIG. 9 is a flow diagram 900 that illustrates an example of a method for detecting if an assertion violates strong-typing. Flow diagram 900 includes four (4) blocks 902-908. Although the actions of flow diagram 900 may be performed in other environments and with a variety of hardware/software/firmware combinations, some of the features, components, and aspects of FIGS. 1-8 are used to illustrate an example of the method. These actions may be performed at the syntactic level, for example.

In a described implementation, at block 902, a first security type of a variable in a security assertion is ascertained. For example, a particular variable at syntactic position #1 702(1) may be established to be of the corresponding security type #1 704(1) based on implicit type assignment from the syntax of the security assertion.

At block 904, it is detected if there is an attempt to bind a second security type to the variable. For example, it may be detected if there is an attempt to bind a value of security type #2 704(2) to the particular variable. This detection may occur at the syntactic level from an analysis of the assertion syntax (e.g., by analyzing variables at syntactic positions 702 corresponding to different security types 704).

If no variable in the security assertion is detected to be attempted to be bound to two different security types, then processing of the security assertion is continued at block 906. On the other hand, if there is a detection (at block 904) of an attempt to bind a second type to the same variable, then at block 908 the security assertion is rejected.

Variables can also be controlled by declaring their type in conjunction with a constraint pattern. For example, a variable r may be declared to be of type resource and required to match a constraint pattern such as {*.txt}. An intent being to limit the concrete values that can bind to the variable r to those resources that are identified by a file name ending in ‘.txt’. As another example, a variable a may be declared to be of type attribute and required to match a constraint pattern such as {email name=*@co_one.com} to limit the concrete values that can bind to the variable a to those attributes that express an email name attribute in the company one domain.

FIG. 10 is a block diagram 1000 illustrating an example of a dual variable binding constraint 610(D) on an assertion 1002. As illustrated, example assertion 1002 includes a number of variables 1004. Although not explicitly illustrated, assertion 1002 may include other portions, such as any of those described above with reference to FIG. 5. The illustrated variables are: assertion variable a 1004(a), assertion variable b 1004(b), assertion variable c 1004(c), and assertion variable d 1004(d).

In a described implementation, assertion 1002 also includes one or more dual variable binding constraints 610(D). One dual variable binding constraint 610(D) is explicitly shown in block diagram 1000. A dual variable binding constraint 610(D), when included as part of an assertion, institutes some constraint on what or which concrete values may bind to two identified variables with respect to each other.

Two examples 610(D1) and 610(D2) of a dual variable binding constraint 610(D) are shown in block diagram 1000. Other implementations are possible, however. Dual variable binding constraint example #1 610(D1) institutes an equal (=) binding constraint on the identified variables. The identified variables are a and b. Hence, with dual variable binding constraint example #1 610(D1), assertion variable a 1004(a) and assertion variable b 1004(b) are constrained to bind to an identical concrete value.

Dual variable binding constraint example #2 610(D2) institutes a not equal (!=) binding constraint on the identified variables. The identified variables are c and d. Hence, with dual variable binding constraint example #2 610(D2), assertion variable c 1004(c) and assertion variable d 1004(d) are constrained to bind to different, non-identical concrete values.

A variable in an assertion may bind to one or more concrete values during an evaluation algorithm of authorization engine 218 (of FIGS. 2 and 3). These bound values are of the correct established type, responsive to the variable definition. Generally, the bound values may also optionally be constrained. The constraints may be expressed using patterns. These patterns may be encoded using any number of well known approaches such as regular expressions or XPath expressions. When a variable is properly constrained, a concrete value is allowed to bind to the variable only if it matches the variable's constraint pattern. General binding constraint patterns are discussed above. Equality and inequality binding constraints are discussed below.

A single policy assertion, or any other assertion, may contain multiple different variables of the same type. For instance, the following assertion policy has three principal variables p1, p2, and p3:

A says p1 predicate1 expression1 if p2 predicate2 expression2,
p3 predicate3 expression3

In a described implementation with such a policy expression, dual variable binding constraint 610(D) enables precise control over whether p1, p2, and/or p3 should or should not bind to the same concrete value during an evaluation. By default, each variable is treated independently. Consequently, they may, but are not required to, bind to the same value during an evaluation.

Explicit variable control is provided by variable equality (e.g., p1=p2) and inequality (e.g., p1=p2) constraints. If, for instance, the desired result was to ensure that p1 and p3 bind to the same value, but that p2 has a different value, the above policy assertion example is modified to add the following variable constraints (e g., to add the following example dual variable binding constraints 610(D) joined by an AND operator):

A says p1 predicate1 expression1 if p2 predicate2 expression2,
p3 predicate3 expression3, ((p1=p3) AND (p1!=p2)).

FIG. 11 is a flow diagram 1100 that illustrates an example of a method for detecting if an assertion conforms to a dual variable binding constraint. Flow diagram 1100 includes five (5) blocks 1102-1110. Although the actions of flow diagram 1100 may be performed in other environments and with a variety of hardware/software/firmware combinations, some of the features, components, and aspects of FIGS. 1-10 are used to illustrate an example of the method. For example, the actions of flow diagram 1100 may occur as part of authorization engine 218.

In a described implementation, at block 1102, it is ascertained if an assertion includes a dual variable binding constraint. For example, it may be ascertained if an assertion 1002 includes a dual variable binding constraint 610(D). If not, then at block 1104 the assertion can be processed normally in the evaluation algorithm.

If, on the other hand, it is ascertained (at block 1102) that the assertion does include a dual variable binding constraint, then at block 1106 a conformance check is made. Specifically, at block 1106 it is detected if a proposed variable substitution set (that renders the assertion valid) conforms to the dual variable binding constraint. If not, then at block 1108 the variable substitution set proposal is rejected for the assertion.

If, on the other hand, it is detected (at block 1106) that the proposed variable substitution set does conform to the dual variable binding constraint, then at block 1110 the variable substitution set proposal for the assertion is accepted. An equivalent approach is to check conformance during the assertion validation process and then propose variable substitution set(s) that are already known to conform to the dual variable binding constraint.

FIG. 12 is a block diagram 1200 illustrating an example assertion 1202 having an assertion variable 1004 that is associated with a single variable binding constraint indicator 610(S). Although only a single assertion variable 1004 is shown in block diagram 1200, example assertion 1202 may include any number of assertion variables 1004 and/or other assertion portions in any order.

In a described implementation, single variable binding constraint indicator 610(S) is at least one character associated with a variable in an assertion. For example, a character may be appended to an alphanumeric representation of a variable in an assertion. When present a single variable binding constraint indicator 610(S) constrains what can be bound to the associated single variable during evaluation. For example, it may indicate that the associated variable may only be bound to concrete values, which therefore excludes bindings to other variables.

In other words, a single variable binding constraint indicator 610(S) can explicitly stipulate variable binding behavior with respect to other variables. The following set of assertions (in which the variables p and x are unconstrained) are presented by way of explanation:

(1) A says B can assert p can assert x read r;

(2) B says C can assert D read Foo; and

(3) B says E can assert y read Foo.

A general question is whether A believes assertion (2) and/or assertion (3) to be valid with respect to its assertion (1). The answer depends on whether the variable “x” is allowed to bind only to a concrete value such as “D” or is allowed to bind to both concrete values and compatible variables such as “y”. (They are compatible variables because they are both of type principal and are unconstrained).

These two cases can be differentiated by marking variables as to their behavior in this regard using a single variable binding constraint indicator 610(S). In a described implementation, by default a variable is permitted to bind to both concrete values and compatible variables. A marked variable, which is associated with a single variable binding constraint indicator 610(S), can only bind to concrete values.

The example above is clarified with the assertion (1*) below. In the assertion (1*) below, a constrained variable is so indicated by marking it with a trailing quote mark (i.e., a character). Both assertions (2) and (3) above are considered valid with respect to assertion (1) when there is no associated single-variable binding constraint indicator because the default then takes precedence. If, however, assertion (1) were modified to be assertion (1*):

(1I) A says B can assert x′ read r,

then assertion (2) is considered valid but assertion (3) is not because the variable “p” is constrained so as to be bindable only to concrete values such as “D”.

The devices, actions, aspects, features, functions, procedures, modules, data structures, protocols, components, etc. of FIGS. 1-12 are illustrated in diagrams that are divided into multiple blocks. However, the order, interconnections, interrelationships, layout, etc. in which FIGS. 1-12 are described and/or shown are not intended to be construed as a limitation, and any number of the blocks can be modified, combined, rearranged, augmented, omitted, etc. in any manner to implement one or more systems, methods, devices, procedures, media, apparatuses, APIs, protocols, arrangements, etc. for variable expressions in security assertions.

Although systems, media, devices, methods, procedures, apparatuses, mechanisms, schemes, approaches, processes, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A system implementing a security scheme comprising a security language that operates with assertions, wherein the security language implicitly assigns a type to variables of a given assertion based on syntactic positions of the variables within the given assertion, the type selected from a set of predefined security-related types.

2. The system as recited in claim 1, wherein the set of predefined security-related types comprises two or more base types selected from a group of base types comprising: principal, action verb, resource, attribute, and at least one specifically-identified environmental qualifier.

3. The system as recited in claim 1, wherein the set of predefined security-related types comprises base types that include: principal, action verb, resource, attribute, date-time, and location.

4. The system as recited in claim 1, wherein the security scheme enforces strong-typing by ensuring that each variable within each assertion binds to no more than a single type of the set of predefined security-related types.

5. The system as recited in claim 1, wherein the security language includes an ability to specify a dual variable binding constraint that stipulates whether two variables of a same type are to bind to different concrete values or are to bind to identical concrete values.

6. The system as recited in claim 1, wherein the security language includes an ability to specify a single variable binding constraint that stipulates that an associated single variable is to bind to concrete values and not to other variables.

7. The system as recited in claim 1, wherein the security language establishes a corresponding type from among the set of predefined security-related types for each syntactic position of the given assertion.

8. The system as recited in claim 1, wherein the security language enables variables to be controlled by declaring their type in conjunction with a constraint pattern.

9. A device implementing a security language that operates with assertions, wherein the device enforces strong-typing for variables by validating that each variable binds to only a single type, the single type selected from a set of predefined security-related types.

10. The device as recited in claim 9, wherein the strong-typing enforcement is applied at an assertion granularity such that each variable of a given assertion is permitted to bind to only a single type within the given assertion.

11. The device as recited in claim 9, wherein the strong-typing enforcement is applied at a syntactic level by rejecting any assertion that includes a particular variable that is present at two syntactic positions corresponding to two different types.

12. The device as recited in claim 9, wherein the device processes a single variable binding constraint that is associated with a variable by constraining the variable to bind to a concrete value while preventing the variable from binding to another variable.

13. The device as recited in claim 9, wherein the set of predefined security-related types comprises two or more base types selected from a group of base types comprising: principal, action verb, resource, attribute, and at least one specifically-identified environmental qualifier.

14. The device as recited in claim 9, wherein the device processes a dual variable binding constraint included as part of an assertion by enforcing a stipulation as to whether two variables of a same type are to bind to different concrete values or are to bind to identical concrete values.

15. The device as recited in claim 9, wherein the device executes the security language by enabling variables to be controlled through a declaration of their type in conjunction with a constraint pattern to which they are to adhere.

16. A system implementing a security scheme comprising a variable binding constraint mechanism that enables an author of an assertion to constrain binding behavior of two or more variables with respect to each other when the two or more variables are of a same type.

17. The system as recited in claim 16, wherein the two or more variables comprise a first variable and a second variable; and wherein the variable binding constraint mechanism comprises a dual variable binding constraint that stipulates whether the first variable and the second variable are to bind to an identical concrete value.

18. The system as recited in claim 17, wherein the dual variable binding constraint comprises an equality constraint stipulating that the first variable and the second variable are to be bound to the identical concrete value.

19. The system as recited in claim 17, wherein the dual variable binding constraint comprises an inequality constraint stipulating that the first variable and the second variable cannot be bound to the identical concrete value.

20. The system as recited in claim 16, wherein the variable binding constraint mechanism comprises a single variable binding constraint indicator that indicates when a variable of the two or more variables is constrained to bind to a concrete value while being prevented from binding to another variable.
